(19) United States
(12) Patent Application Publication
(10) Pub. No.: US 2015/0290675 A1
(43) Pub. Date: Oct. 15, 2015

(54) PORTABLE LIGHT EMITTING DEVICE AND A LAMP EQUIPPED WITH IT

(71) Applicant: Genius Electronic Optical Co., Ltd., Taichung City (TW)

(72) Inventor: Chih-Shen LIN, Taichung City (TW)

(73) Assignee: Genius Electronic Optical Co., Ltd.

(21) Appl. No.: 14/674,676

(22) Filed: Mar. 31, 2015

(30) Foreign Application Priority Data
Apr. 14, 2014 (TW) 103113510

(51) Int. Cl. B05D 3/06; F21V 33/00; F21S 9/00; F21V 23/00

(52) U.S. Cl. CPC B05D 3/067; F21V 23/003; F21V 33/0004; F21S 9/00; F21Y 2101/02

(57) ABSTRACT

A portable light emitting device and a lamp equipped with it. The portable light emitting device includes a housing and a light emitting unit, and is designed for insertion of a single finger and is therefore very compact to carry. Besides, the light emitting unit is able to selectively produce visible light and UV light, the visible light is used for illumination purpose, and the UV light can dry the nail polish, so that the light emitting device become more versatile and provides more added values. The light emitting device can further be used as an illumination lamp, such as a desk lamp, when in combination with a support, which further improves the versatility and convenience of use of the light emitting device.

### BACKGROUND OF THE INVENTION

1. Field of the Invention

The present invention relates to a portable light emitting device and a lamp equipped with it, and more particularly to a portable light emitting device which can be used as an illumination device and a nail polish dryer as well.

2. Description of the Prior Art

Lights with different wavelengths have different features and generally include ultraviolet light, visible light and infrared light. In addition to illumination, lights of different wavelengths can also be applied to different fields based on their different features.

For example, Ultraviolet light has been widely applied to beauty industry in recent years as an UV light nail dryer which is used to dry the nail polish coated on the nail.

FIG. 1 shows a conventional UV light nail dryer 10 which comprises a meniscus-shaped housing 11 which defines a gap 111, and on the inner surface of the housing 11 is disposed a plurality of UV light emitting diodes, so that t the user's fingers can be inserted into the gap 111 to dry the polish. Since the light source of the conventional UV light nail dryer 10 is UV light, the UV light nail dryer 10 can just be used as a nail dryer 10, resulting in a limited applicability. Besides, the housing 11 has to be big enough to allow for insertion of all the five fingers of the user at a time, which makes the housing 11 not compact and inconvenient to carry.

The present invention has arisen to mitigate and/or obviate the afore-described disadvantages.

### SUMMARY OF THE INVENTION

The primary objective of the present invention is to provide a light emitting device which is more versatile and compact to carry as compared with the conventional lamp.

To achieve the above objective, a portable light emitting device in accordance with the present invention comprises a housing and a light emitting unit. The housing is a three dimensional structure extending along a length direction, a width direction and a height direction, respectively. The length direction, the width direction and the height direction are perpendicular to one another, and the housing includes a chamber and a gap. The chamber includes a top open end and an inner surface arranged along the height direction, and a maximum chamber height disposed between the top open end and the inner surface and extending along the height direction. The gap is in communication with the chamber and one end of the housing in the length direction, another end of the housing in the length direction is a close end, the chamber has a chamber length L extending from the gap to the close end of the housing, the gap includes a maximum gap height extending along the height direction, and the maximum gap height is smaller than the maximum chamber height. The gap includes a maximum width in the width direction, and the maximum chamber height is between 2 cm and 7 cm, the maximum gap height is between 1.5 cm and 5 cm, the chamber length is between 2 cm and 6 cm, and the width of the gap is between 2 cm and 3.5 cm.

The light emitting unit is disposed in the housing and able to selectively generate a visible light and a UV light.

To achieve the above objective, a lamp equipped with the portable light emitting device in accordance with the present invention comprises a housing, a light emitting unit and a support. The housing is a three dimensional structure extending along a length direction, a width direction and a height direction, respectively. The length direction, the width direction and the height direction are perpendicular to one another, and the housing includes a chamber and a gap. The chamber includes a top open end and an inner surface arranged along the height direction, and a maximum chamber height disposed between the top open end and the inner surface and extending along the height direction. The gap is in communication with the chamber and one end of the housing in the length direction, another end of the housing in the length direction is a close end, the chamber has a chamber length L extending from the gap to the close end of the housing, the gap includes a maximum gap height extending along the height direction, and the maximum gap height is smaller than the maximum chamber height. The gap includes a maximum width in the width direction, and the maximum chamber height is larger than 2 cm, the maximum gap height is larger than 1.5 cm, the chamber length is larger than 2 cm, and the width of the gap is larger than 2 cm.

The light emitting unit is disposed in the housing and able to selectively generate a visible light and a UV light.

The support is removably assembled to a mounting portion of the housing via a connecting portion.

The portable light emitting device of the present invention is designed for insertion of a single finger and therefore is very compact to carry. Besides, the light emitting unit is able to selectively produce visible light and UV light, the visible light is used for illumination purpose, and the UV light dries the nail polish, so that the light emitting device is versatile and provides more added value. The light emitting device of the present invention can further be used in combination with the support, which further improves the versatility and convenience of use of the light emitting device.

### BRIEF DESCRIPTION OF THE DRAWINGS

FIG. 1 shows a conventional nail polish dryer;

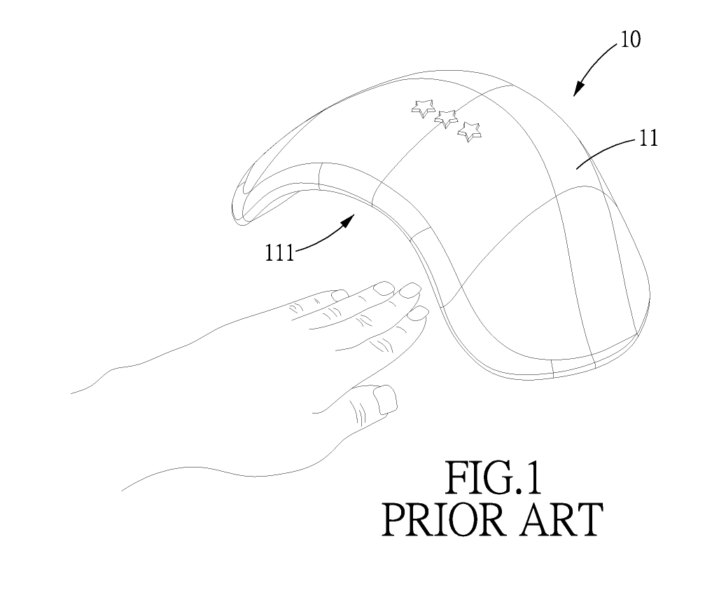

FIG. 2 is a perspective view of a portable light emitting device in accordance with a first preferred embodiment of the present invention;

FIG. 3 is another perspective view of the portable light emitting device in accordance with the first preferred embodiment of the present invention;

FIG. 4 is a cross sectional view of the portable light emitting device in accordance with the first embodiment of the present invention;

FIG. 5 is a cross sectional view of a portable light emitting device in accordance with a second embodiment of the present invention;

FIG. 6 is a cross sectional view of a portable light emitting device in accordance with a third embodiment of the present invention;

FIG. 7 is a cross sectional view of a portable light emitting device in accordance with a fourth embodiment of the present invention;

FIG. 8 is an illustrative view showing that a user's finger is inserted in the portable light emitting device in accordance with the present invention;

FIG. 9 is another illustrative view showing that a user's finger is inserted in the portable light emitting device in accordance with the present invention;

FIG. 10 is an illustrative view showing that the portable light emitting device in accordance with the present invention is used as a desk lamp when in combination with a support; and

FIG. 11 shows that the portable light emitting device in accordance with the present invention is used in combination with a clamp.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

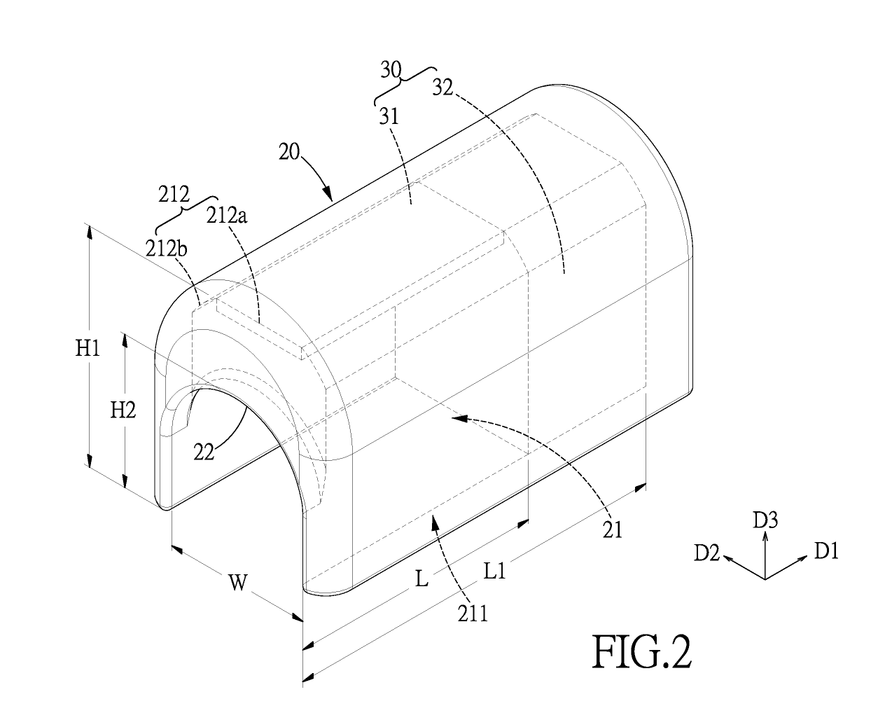

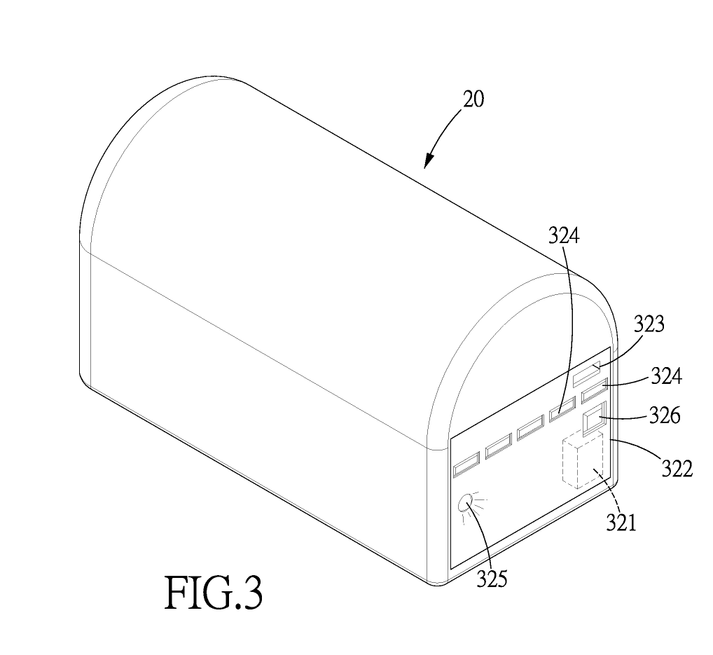

Referring to FIGS. 2-11, a portable light emitting device in accordance with a preferred embodiment of the present invention comprises: a housing 20 and a light emitting unit 30.

The housing 20 is a three dimensional structure extending along a length direction D1, a width direction D2 and a height direction D3, respectively. The length direction D1, the width direction D2 and the height direction D3 are perpendicular to one another. The housing 20 includes a chamber 21 and a gap 22.

The chamber 21 has a top open end 211 and an inner surface 212 arranged along the height direction D3, and a maximum chamber height H1 disposed between the top open end 211 and the inner surface 212 and extending along the height direction D3.

The housing 20 has a total length L1 extending in the length direction D1. The gap 22 is in communication with the chamber 21 and one end of the housing 20 in the length direction D1. Another end of the housing 20 in the length direction D1 is a close end. The chamber 21 has a chamber length L extending from the gap 22 to the close end of the housing 20. The gap 22 has a maximum gap height H2 extending along the height direction D3, and the maximum gap height H2 is smaller than the maximum chamber height H1. The gap 22 further has a maximum width W in the width direction D2, and they satisfy the following equations: 2 cm<H1<7 cm, 1.5<H2<5 cm, 5 cm<L1<10 cm, 2 cm<L<6 cm, and 2 cm<W<3.5 cm.

The light emitting unit 30 is disposed in the housing 20 and selectively able to generate a visible light and a UV light. The light emitting unit 30 includes a light source 31 and a controller 32 which are electrically connected to each other.

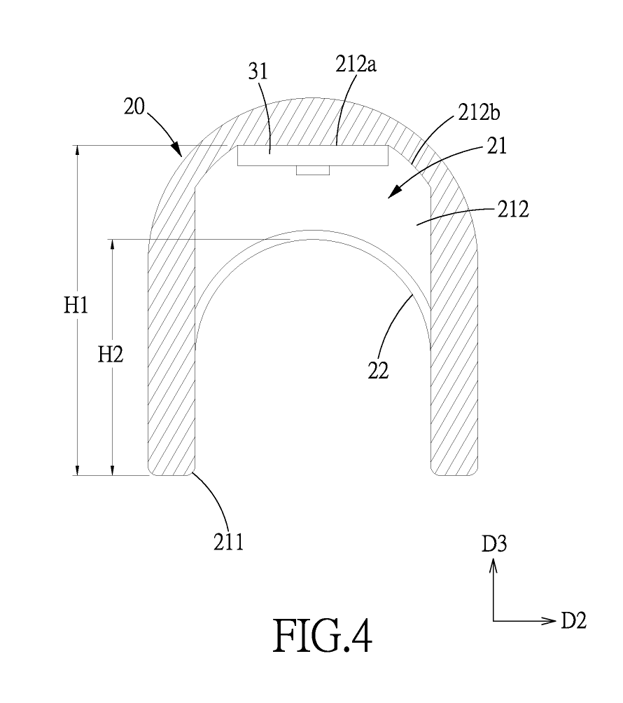

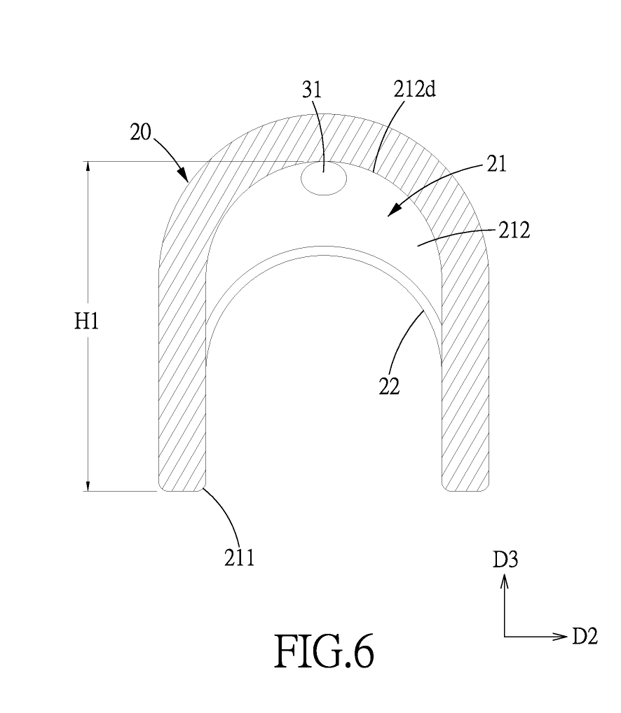

The light source 31 is disposed at the inner surface 212 of the chamber 21. In this embodiment, the light source 31 includes a plurality of polycrystalline package LEDs (light emitting diodes) capable of selectively generating lights of different wavelengths. The LEDs include ultraviolet light LED of wavelength 400 nm, red light LED of wavelength 635 nm, blue light LED of wavelength 435 nm, green light LED of wavelength 525 nm, or yellow light LED of wavelength 575 nm. The ultraviolet light LED is used to dry nail polish. The red light LED can reduce fine lines, coarse pores, and postoperative swelling. The blue light LED provides the functions of sterilization, pimple treatment, skin soothe and protection against allergies. The green light LED generates green light to protect against wrinkle, skin aging, nourish the skin, accelerate wound healing and reduce scar. The yellow light LED produces yellow light to strengthen muscles and immune system, and soothe and balance sensitive skin. The light source 31 can be a light panel (as shown in FIG. 4) or light bulb (as shown in FIG. 6). The number and package of the LEDs can be varied in different applications or embodiments, and the wavelength of the lights produced by the LEDs can be, but not limited to, 660 nm, 580 nm, 530 nm, 400 nm. It is to be noted that, when the red, blue and green LEDs are turned on simultaneously, the produced lights are mixed and turned into a cool white light which can be used for normal illumination or emergency illumination. When the red, blue, green and yellow light LEDs are turned on simultaneously, the produced lights will be mixed into a warm white light to work as atmospheric light.

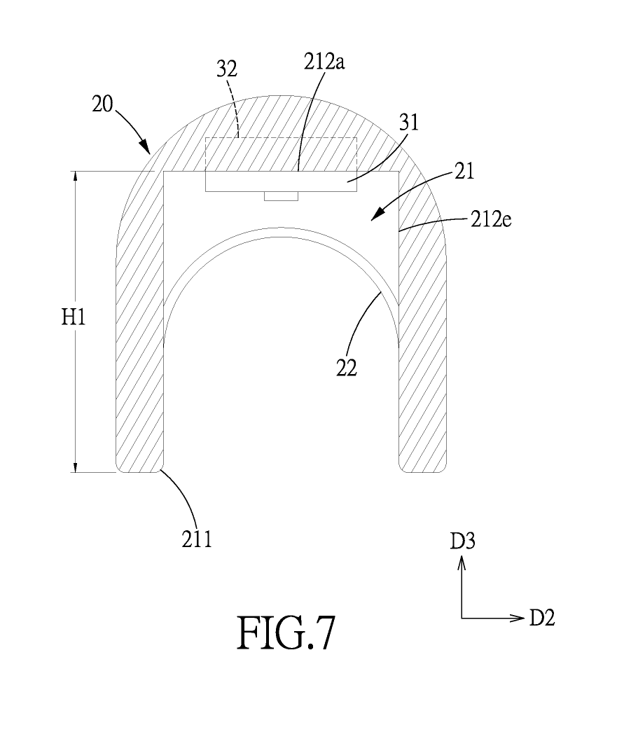

The controller 32 is disposed at and closes the another end of the housing 20 opposite the gap 22, and comprises a power source 321 and a control panel 322 which are electrically connected to each other. The control panel 322 is exposed out of the housing 20 and includes a power interface 323, a plurality of control portions 324, and a display portion 325. The power interface 323 is electrically connected to the light source 31. The controller 32 is controlled by the control panel 322 to change the wavelength of the light generated by the light source 31. The display portion 325 shows the status of the light source 31 and can take the form of a light emitting element or electronic display panel capable of changing color or displaying English characters based on the wavelength of the light source. For example, the character “R” will be displayed on the display portion 325 or a red light of the display portion 325 will be turned on when red light is generated from the light source 31. There can also be only one control portion 324, and the number of pressing the control portion 324 is used to control the wavelength of the light of the light source. The controller 32 can also be disposed at the location as shown in FIG. 7. The control panel 322 can further be provided with a cancel portion 326 in order to prevent the user from activating the ultraviolet light by mistake. The ultraviolet light can be activated only when the cancel portion 326 is pressed. The cancel portion 326 can also be omitted in other embodiments, and voice signal or other methods can be used to remind the user the activation status of the ultraviolet light.

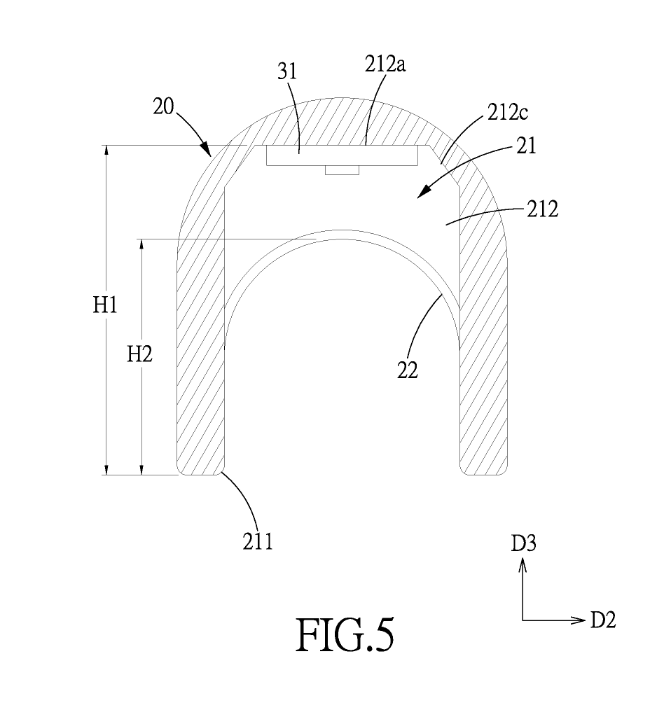

It is to be noted that the inner surface 212 of the chamber 21 of the housing 20 includes a flat bottom surface 212a and two arc-shaped lateral surfaces 212b connected to two ends of the flat bottom surface 212a. The maximum chamber height H1 is defined between the top open end 211 and the flat bottom surface 212a. The inner surface 212 of the chamber 21 is not limited to the aforementioned structure, and can also include a flat bottom surface 212a and two inclined flat surfaces 212c connected to two ends of the flat bottom surface 212a, as shown in FIG. 5, and the maximum chamber height H1 is defined between the top open end 211 and the flat bottom surface 212a. The inner surface 212 of the chamber 21 can also consist of an arc-shaped surface 212d, and the maximum chamber height H1 is defined between the top open end 211 and the vertex of the arc-shaped surface 212d, as shown in FIG. 6. The inner surface 212 of the chamber 21 can also consist of a flat bottom surface 212a and two flat lateral surfaces 212e connected to two ends of the flat bottom surface 212a, and the maximum chamber height H1 is defined between the top open end 211 and the flat bottom surface 212a, as shown in FIG. 7. With the arrangement of the arc-shaped lateral surfaces 212b, the inclined flat surfaces 212c and the arc-shaped surface 212d of the chamber 21, the light generated from the light emitting unit 30 can be improved in light uniformity through refraction, without using reflection cup, so as to improve the added value of the product.

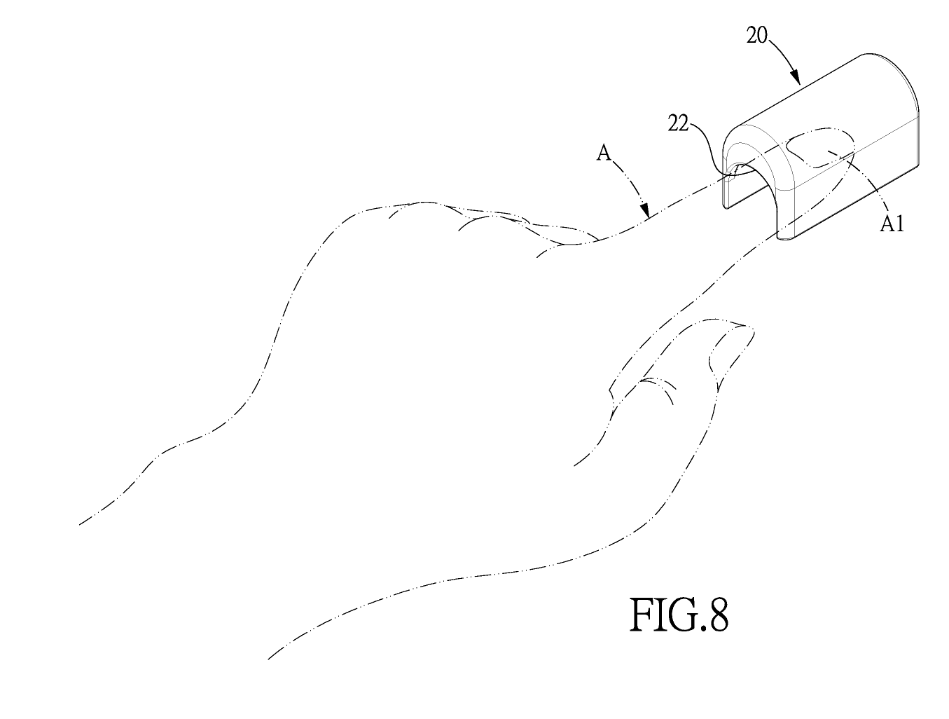

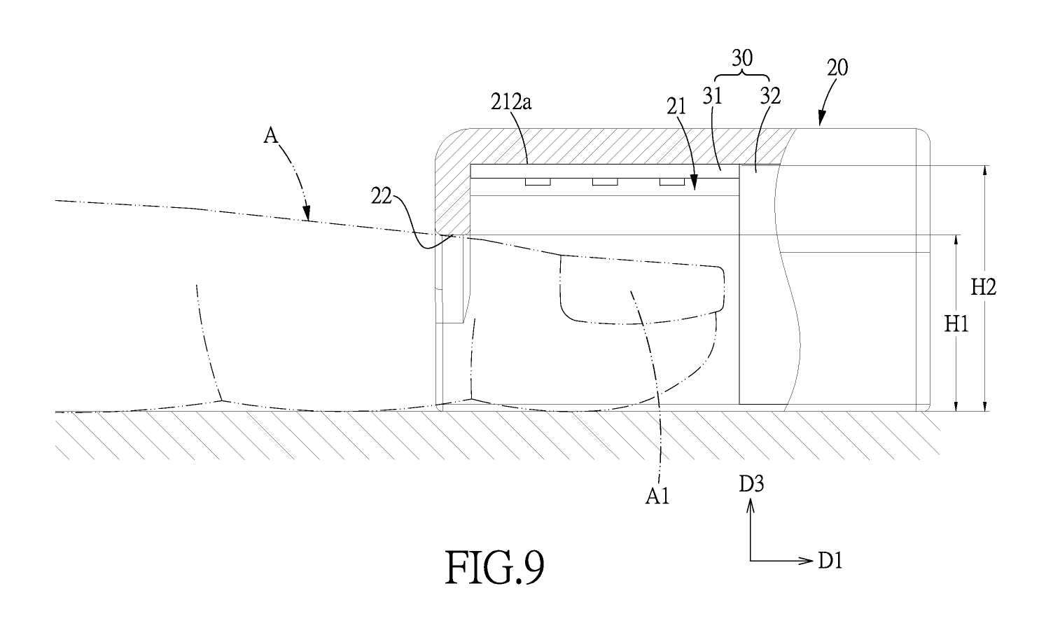

The portable light emitting device of the present invention is particularly suitable for use as nail polish dryer, as shown in FIGS. 8 and 9, the user's finger A is inserted through the gap 22 to move the nail Al into the chamber 21. Then, the light emitting unit 30 is turned on, so that UV light is produced from the light source 31 to dry the nail polish. Since the maximum gap height H2 is smaller than the maximum chamber height H1, the portion of the chamber 21 higher than the gap 22 can be completely prevented from light leakage, so as to enhance light out coupling efficiency.

In addition to being used as nail polish dryer, the portable light emitting device of the present invention can also be used as mini illumination device or beauty lamp. The user can choose the type of visible light needed by using the control portions 324 of the control panel 322 of the controller 32, and then the display portion 325 will display the type of the selected visible light for the user to check. The selected visible light can be used for illumination or beauty treatment purpose.

The controller 32 can be provided with either or both of the power source 321 and the power interface 323. The power source 321 can be a replaceable ordinary battery. The power interface 323 can be connected to a power source to supply power and can take the form of a USB port or a AC power connector. The power source 321 can be a rechargeable battery. When the power interface 323 is electrically connected to an external power source, the power source 321 can be recharged. The power interface 323 and the power source 321 are not limited to the aforementioned forms.

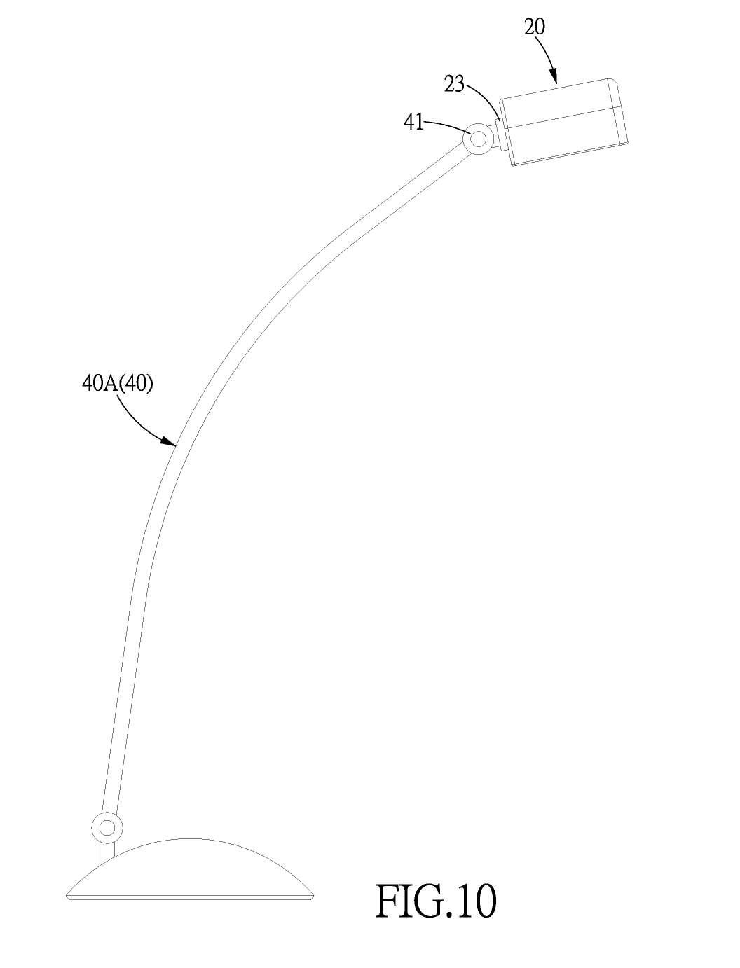

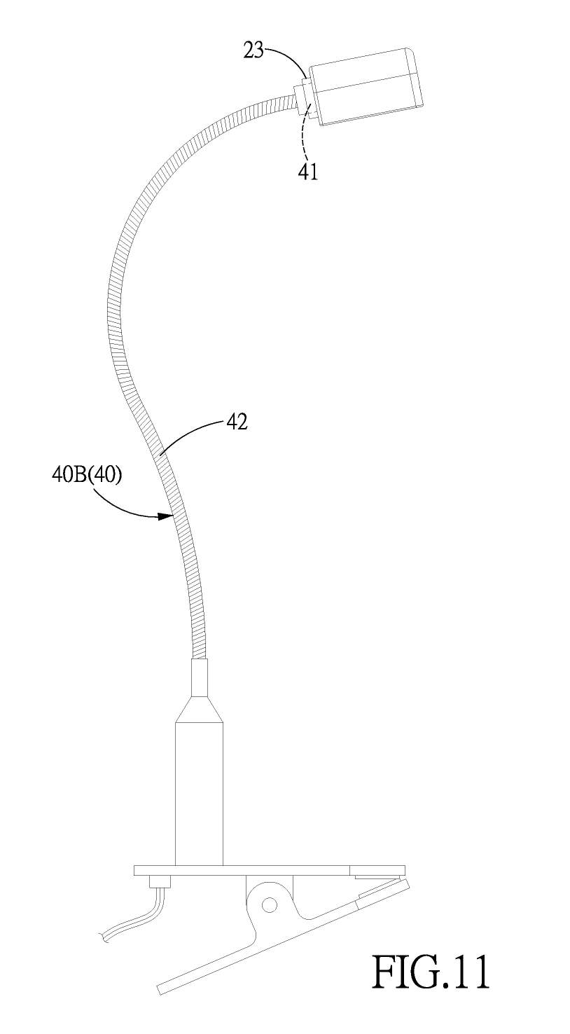

In addition to be used as a mini handhold illumination device, the portable light emitting device of the present invention can also be used as a desk lamp when in combination with a support 40. Besides, the housing 20 is further provided with a mounting portion 23 which is located at the another end of the housing 20 in the length direction D1, so that the support 40 can be removably assembled to the mounting portion 23 of the housing 20 via a connecting portion 41. The support 40 can take the form of a stand 40A a, as shown in FIG. 10, to allow the portable light emitting device to be pivoted to the stand 40A, or can take the form of a clamp 40B with a flexible rod 42, as shown in FIG. 11, and the housing 20 of the portable light emitting device of the present invention is removably assembled to the connecting portion 41 at the end of the flexible rod 42. The connecting portion 41 and the mounting portion 23 can also be electrically connected to each other, so that the support 40 can be used not only as a support member but as an electric connecting means as well.

The portable light emitting device of the present invention is designed for insertion of a single finger A and therefore is very compact to carry. Besides, the light emitting unit is able to selectively produce visible light and UV light, the visible light is used for illumination purpose, and the UV light dries the nail polish, so that the light emitting device is versatile and provides more added value. The light emitting device of the present invention can further be used in combination with the support 40, which further improves the versatility and convenience of use of the light emitting device.

While we have shown and described various embodiments in accordance with the present invention, it is clear to those skilled in the art that further embodiments may be made without departing from the scope of the present invention.

What is claimed is:

1. A portable light emitting device comprising:
a housing being a three dimensional structure extending along a length direction, a width direction and a height direction, respectively, the length direction, the width direction and the height direction being perpendicular to one another, the housing including a chamber and a gap, the chamber including a top open end and an inner surface arranged along the height direction, and a maximum chamber height disposed between the top open end and the inner surface and extending along the height direction, the gap being in communication with the chamber and one end of the housing in the length direction, another end of the housing in the length direction being a close end, the chamber having a chamber length extending from the gap to the close end of the housing, the gap including a maximum gap height extending along the height direction, and the maximum gap height being smaller than the maximum chamber height, the gap including a maximum width in the width direction, and the maximum chamber height is between 2 cm and 7 cm, the maximum gap height is between 1.5 cm and 5 cm, the chamber length is between 2 cm and 6 cm, and the width of the gap is between 2 cm and 3.5 cm; and
a light emitting unit being disposed in the housing and able to selectively generate a visible light and a UV light.

2. The portable light emitting device as claimed in claim 1, wherein the light emitting unit includes a light source and a controller which are electrically connected to each other, the light source is disposed at the inner surface of the chamber, and the controller is disposed at and closes the another end of the housing opposite the gap.

3. The portable light emitting device as claimed in claim 2, wherein the light source includes a plurality of light emitting diodes capable of selectively generating lights of different wavelengths.

4. The portable light emitting device as claimed in claim 2, wherein the controller includes a control panel which is exposed out of the housing, the control panel includes at least one control portions and a display portion, and the controller is controlled by the control panel to change the wavelength of the light generated by the light source.

5. The portable light emitting device as claimed in claim 4, wherein the controller further includes a power source.

6. The portable light emitting device as claimed in claim 4, wherein the control panel further comprises a power interface.

7. The portable light emitting device as claimed in claim 1, wherein the inner surface of the chamber of the housing includes a flat bottom surface and two arc-shaped lateral surfaces connected to two ends of the flat bottom surface, and the maximum chamber height is defined between the top open end and the flat bottom surface.

8. A lamp equipped with a portable light emitting device comprising:
a housing being a three dimensional structure extending along a length direction, a width direction and a height direction, respectively, the length direction, the width direction and the height direction being perpendicular to one another, the housing including a chamber and a gap, the chamber including a top open end and an inner surface arranged along the height direction, and a maximum chamber height disposed between the top open end and the inner surface and extending along the height direction, the gap being in communication with the chamber and one end of the housing in the length direction, another end of the housing in the length direction being a close end, the chamber having a chamber length extending from the gap to the close end of the housing, the gap including a maximum gap height extending along the height direction, and the maximum gap height being smaller than the maximum chamber height, the gap including a maximum width in the width direction, and the maximum chamber height is larger than 2 cm, the maximum gap height is larger than 1.5 cm, the chamber length is larger than 2 cm, and the width of the gap is larger than 2 cm;
a light emitting unit being disposed in the housing and able to selectively generate a visible light and a UV light; and
a support being removably assembled to a mounting portion of the housing via a connecting portion.

9. The lamp equipped with the portable light emitting device as claimed in claim 8, wherein the mounting portion is located at the another end of the housing in the length direction.

10. The lamp equipped with the portable light emitting device as claimed in claim 9, wherein the connecting portion and the mounting portion are electrically connected to each other.
